(19) United States
(12) Patent Application Publication
(10) Pub. No.: US 2011/0234913 A1
(43) Pub. Date: Sep. 29, 2011

(54) CONTROLLING ARTIFACTS IN VIDEO DATA

(76) Inventors: Ramin Samadani, Palo Alto, CA (US); Wai-Tian Tan, Sunnyvale, CA (US)

(21) Appl. No.: 13/132,396

(22) PCT Filed: Dec. 16, 2008
(86) PCT No.: PCT/US2008/087049

§ 371 Date: Jun. 2, 2011

(51) Int. Cl. H04N 5/14

(52) U.S. Cl. 348/701; 348/E05.065

(57) ABSTRACT

Controlling artifacts in video data. Image data of collocated pixels of a plurality of frames of the video data is sampled (310), wherein at least a portion of each of the plurality of frames corresponds to an object that does not move across the plurality of frames. A statistical curve fit is performed (320) on sampled image data of the collocated pixels, wherein the statistical curve fit places less consideration on a sampled collocated pixel that corresponds to movement of an object across the plurality of frames. An adjusted frame is generated (330) based at least in part on at least one parameter of the statistical curve fit.

### FIELD

Various embodiments of the present invention relate to the field of video processing.

### BACKGROUND

Typical video capture pipelines employ compression and processing for analysis and enhancement. In general, typical compression and processing does not model changes in picture brightness induced by the automatic exposure control of cameras, which often randomly produce artifacts. Moreover, these brightness changes can result in global changes to the entire video frame, including the stationary background. Limitations in rate control and bandwidth at the encoder then cause these global brightness changes to appear as the distracting blocks.

### BRIEF DESCRIPTION OF THE DRAWINGS

The accompanying drawings, which are incorporated in and form a part of this specification, illustrate embodiments of the present invention:

FIG. 1 is a block diagram of a system for controlling artifacts in video data, in accordance with one embodiment of the present invention.

FIG. 2A is a plot of an example robust line fit for an example frame, in accordance with one embodiment of the present invention.

FIG. 2B is a plot of an example robust line fit for an example frame including more motion than the example frame of FIG. 2A, in accordance with one embodiment of the present invention.

FIG. 2C is a plot of an example robust line fit for an example frame including more motion than the example frame of FIG. 2A compared to a standard least squares fit, in accordance with one embodiment of the present invention.

FIG. 3 is a flowchart illustrating a process for controlling artifacts in video data, in accordance with one embodiment of the present invention.

The drawings referred to in the description of embodiments should not be understood as being drawn to scale except if specifically noted.

### DESCRIPTION OF EMBODIMENTS

Various embodiments of the present invention, controlling artifacts in video data, are described herein. In one embodiment, a method for controlling artifacts in video data is described. Image data of collocated pixels of a plurality of frames of the video data is sampled, wherein at least a portion of each of the plurality of frames corresponds to an object that does not move across the plurality of frames. A statistical curve fit is performed on sampled image data of the collocated pixels, wherein the statistical curve fit places less consideration on a sampled collocated pixel that corresponds to movement of an object across the plurality of frames. An adjusted frame is generated based at least in part on at least one parameter of the statistical curve fit.

In order to reduce the spurious artifacts a simple, efficient and low-delay method for compensating for the camera lighting changes using pixel values alone is desirable. Embodiments of the present invention provide a low-delay solution that can be inserted as an independent module between any camera and processing module. In this way, cameras with different automatic exposure algorithms and capabilities can be used interchangeably for communications applications.

Embodiments of the present invention provide a method for controlling blocking artifacts caused by automatic exposure control or automatic gain control (AGC) of stationary video cameras. For example, video conferencing typically employs the use of a stationary camera to record a presentation. Video conferencing without controlled lighting often suffers from the spurious AGC readjustments, e.g., as commonly seen in typical webcams. Because current video encoders do not model intensity changes, these AGC errors in turn can cause severe blocking artifacts. Embodiments of the present invention provide for controlling such artifacts.

Various embodiments of the present invention provide for controlling artifacts in video data by distinguishing AGC errors from actual changes in the video data. Embodiments of the present invention rely on pixel values alone, and can be inserted as an independent module between any video capture device, e.g., camera, and processing modules. Therefore, cameras with differing AGC functions and capabilities can be used interchangeably for communications applications.

Reference will now be made in detail to various embodiments of the present invention, examples of which are illustrated in the accompanying drawings. While the present invention will be described in conjunction with the various embodiments, it will be understood that they are not intended to limit the invention to these embodiments. On the contrary, embodiments of the present invention are intended to cover alternatives, modifications and equivalents, which may be included within the spirit and scope of the appended claims. Furthermore, in the following description of various embodiments of the present invention, numerous specific details are set forth in order to provide a thorough understanding of embodiments of the present invention. In other instances, well known methods, procedures, components, and circuits have not been described in detail as not to unnecessarily obscure aspects of the embodiments of the present invention.

For purposes of the instant description of embodiments, video data refers to data that includes image data representative of physical objects. In various embodiments, video data includes a plurality of frames representative of still images of physical objects. For example, the image data includes frames representative of at least a portion of a photographic image of a physical object. Embodiments of the present invention provide for adjusting, e.g., transforming, the input image data to control for blocking artifacts, by generating adjusted image data.

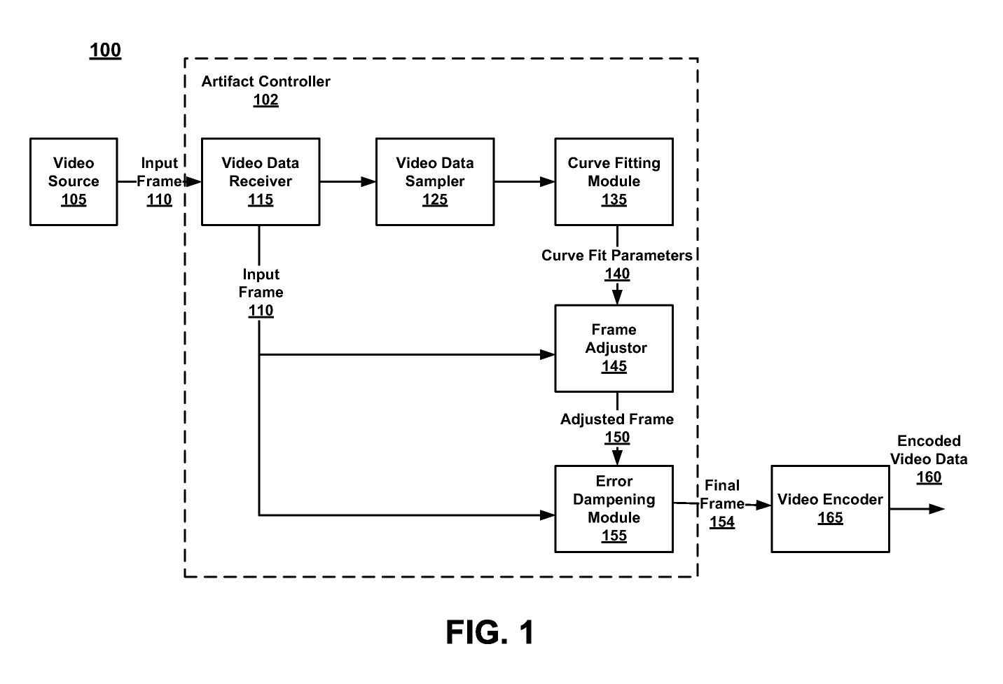

FIG. 1 is a block diagram of a system 100 for controlling artifacts in video data, in accordance with one embodiment of the present invention. System 100 includes artifact controller 102 that includes video data receiver 115, video data sampler 125, curve fitting module 135, and frame adjuster 145. In one embodiment, system 100 also includes error dampening module 155. In one embodiment, system 100 also includes video encoder 165. In one embodiment, system 100 also includes video source 105.

In one embodiment, system 100 is implemented in a computing device capable of receiving video data. For example, system 100 may be any type of computing device, including without limitation computers, digital camera, webcam, cellular telephones, personal digital assistants, television sets, set-top boxes, and any other computing device capable of receiving or capturing video data.

It should be appreciated that artifact controller 102, video source 105, video data receiver 115, video data sampler 125, curve fitting module 135, frame adjuster 145, error dampening module 155 and video encoder 165 can be implemented as hardware, firmware, software and hardware, software and firmware, and hardware, software and firmware. Moreover, it should be appreciated that system 100 may include additional components that are not shown so as to not unnecessarily obscure aspects of the embodiments of the present invention.

In one embodiment, video source 105 provides input frame 110 of video data to artifact controller 102. It should be appreciated that video source 105 provides a plurality of input frames to artifact controller 102, and that a single input frame 110 is shown for simplicity of illustration. For example, video source 105 provides an entire video file including a plurality of sequential video frames to artifact controller 102.

In one embodiment, the video data of video source 105 is raw video data, e.g., has not been encoded. In another embodiment, the video data of video source 105 has been processed, e.g., has been color transformed. Moreover, it should be appreciated that video source 105 can be any device or module for storing or capturing video data. For example, and without limitation, video source 105 can include a video storage device, a memory device, a video capture device, or other video data devices.

It should be appreciated that embodiments of the present invention rely on the assumption that the video data was captured by a substantially stationary video capture device. In other words, the video data is captured by a stationary camera and at least a portion of each of the plurality of frames corresponds to an object that does not move across the plurality of frames.

Video data receiver 115 receives a plurality of input frames 110 from video source 105, and is configured to forward input frames 110 to video data sampler 125 and frame adjuster 145. In one embodiment, video data receiver 115 is configured to forward input frames 110 to error dampening module 155.

Video data sampler 125 is operable to sample image data of collocated pixels of the plurality of frames, wherein at least a portion of each of the plurality of frames corresponds to an object that does not move across the plurality of frames. In one embodiment, the plurality of frames includes consecutive input frames 110 of the video data. In one embodiment, the sampled image data includes luminance data. In one embodiment, the sampled image data includes RGB color space data. It should be appreciated that the sampled image data can include other types of data, and is not intended to be limited to the described embodiments. In particular, any image data that allows for the detection of movement across a plurality of frames can be implemented in various embodiments, e.g., YUV color data.

In one embodiment, video data sampler 125 is configured to sample collocated pixels of the plurality of frames in a grid. For example, a two-dimensional regularly spaced grid can be used. However, it should be appreciated that any or all of the pixels of a frame can be sampled.

Curve fitting module 135 is configured to perform a statistical curve fit on sampled image data of the collocated pixels, wherein the statistical curve fit places less consideration on a sampled collocated pixel that corresponds to movement of an object across the plurality of frames. In various embodiments, the statistical curve fit is a robust statistical curve fit, wherein a curve can refer to a parametric form, a non-parametric form, or a line. In one embodiment, the statistical curve fit includes a statistically robust linear fit. In another embodiment, the statistical curve fit includes a statistically robust parametric form fit. In general, a robust statistical fit, also referred to as robust regression, is designed to reduce the impact of outlier data on the statistical fit. In one embodiment, the statistical curve fit is an iteratively re-weighted least squares (IRLS) fit.

Embodiments of the present invention rely on the assumptions that 1) a portion of pixels in consecutive frames correspond to objects that do not move, e.g., a stationary camera, and 2) the intensity changes for these pixels are due to a global AGC modification. In one embodiment, curve fitting module 135 utilizes the model yᵢ=gᵢxᵢ+oᵢ, where xᵢ is the postulated input i'th video frame before AGC, gᵢ and oᵢ are gain and offset AGC parameters that were subsequently applied to form yᵢ, the AGC modified video frame which is the input to frame adjuster 145. Moreover, a portion of the pixels sampled are outliers that change due to object motion.

In one embodiment, curve fitting module 135 computes a statistically robust fit (yᵢ=aᵢ\hat{x}ᵢ−1+bᵢ) using a regularly-spaced two-dimensional grid of collocated pixels of the current video frame yᵢ and the previous corrected frame \hat{x}ᵢ−1. In the present embodiment, an IRLS line fit that estimates the parameters aᵢ and bᵢ is utilized. This fit gives less consideration to the outliers due to object motion and simply tracks the AGC. It should be appreciated that in other embodiments, outliers are ignored, rather than given less consideration.

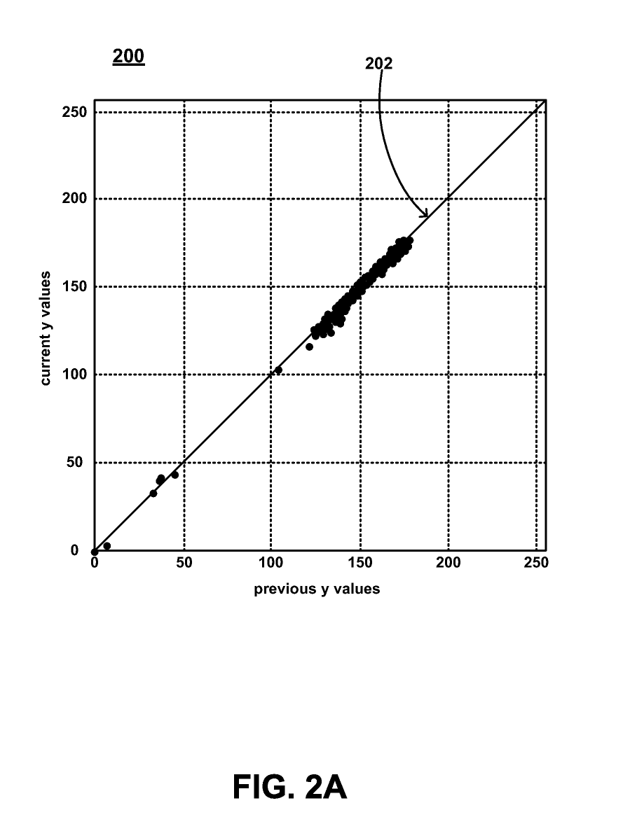

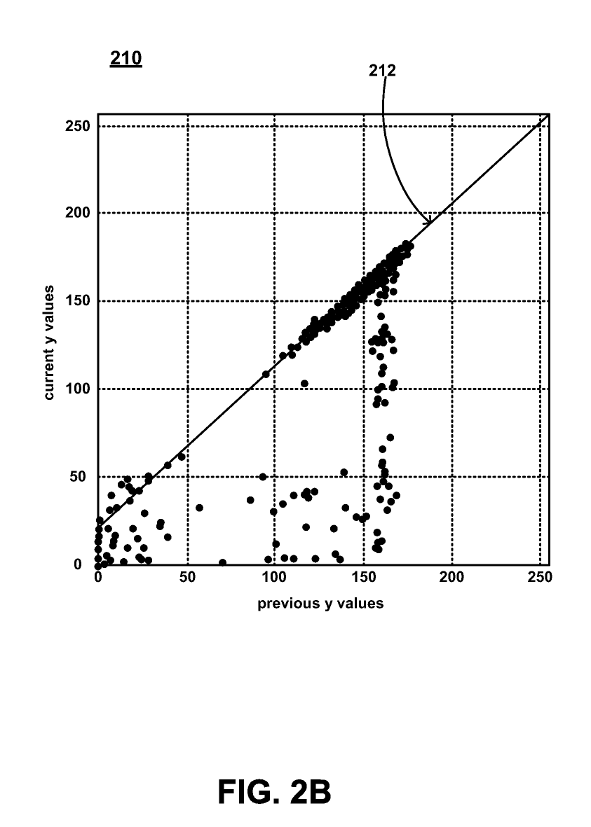

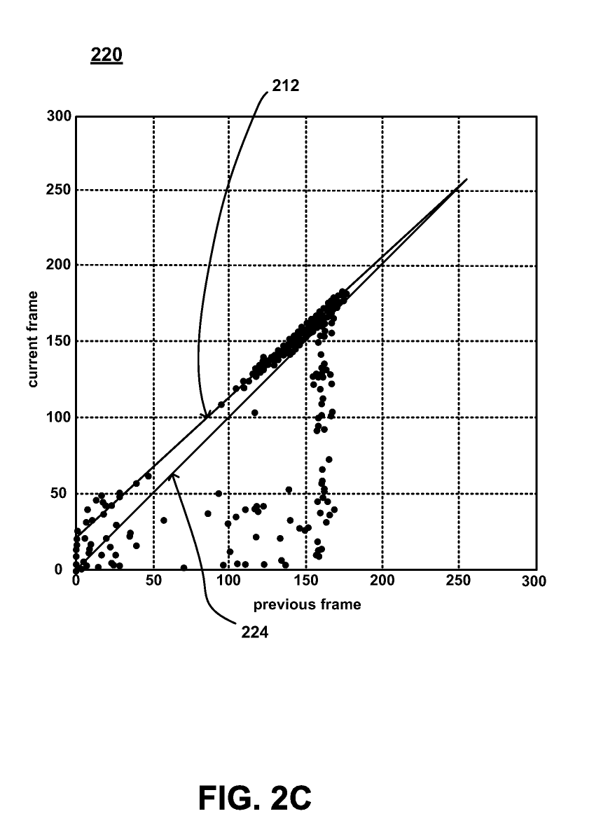

FIGS. 2A through 2C illustrate example plots of robust line fits, in accordance with embodiments of the present invention. In particular, these example plots are of sampled values in a current frame and a sampled value in a previous frame. It should be appreciated that the frames can be consecutive, periodically sampled, randomly sampled, or sampled according to any other sampling methodology. Moreover, it should be appreciated that the line fit can be applied to all color channels simultaneously, only to luminance, or to any other data that would indicate movement across the frames.

FIG. 2A is a plot 200 of an example robust line fit 202 for an example frame, in accordance with one embodiment of the present invention. In particular, example robust line fit 202 is for an example frame with minimal motion, as indicated by the location of most data for current sampled pixels being very close the data for previous sampled pixels.

FIG. 2B is a plot 210 of an example robust line fit 212 for an example frame including more motion than the example frame of FIG. 2A, in accordance with one embodiment of the present invention. As shown in plot 210, the data associated with a number of current sampled pixels have a value different than the data for previous sampled pixels. These data are considered outliers, and their impact on the example robust line fit 212 is reduced by giving them less consideration in performing the line fit. In one embodiment, any data outside of a range is disregarded from the line fit. In another embodiment, as data moves farther from the value in the previous frame, it is given less weight.

FIG. 2C is a plot 220 of example robust line fit 212 compared to a standard least squares fit 224 for the same data, in accordance with one embodiment of the present invention. The standard least squares fit does not reweight or disregard outlying data. As such, the standard least squares fit is skewed towards the outlying data. By not accounting for the effect of outliers on the line fit, standard least squares does not provide as accurate a line fit as a robust line fit.

Returning to FIG. 1, curve fitting module 135 is operable to extract curve fit parameters 140 from the robust line fit. In one embodiment, the curve fit parameters 140 include gain and offset. Frame adjuster 145 is configured to generate an adjusted frame 150, also referred to herein as an intermediate frame, based at least in part on curve fit parameters 140. As shown, frame adjuster 145 receives the corresponding input frame 110, and generates an adjusted frame 150 by applying the curve fit parameters to the corresponding input frame 110. For example, in accordance with one embodiment, using the robust fit parameters aᵢ and bᵢ defined above, adjusted frames 150 \hat{z}ᵢ=(yᵢ−bᵢ)/aᵢ, are generated, wherein the initial condition is \hat{z}₀=y₀.

In one embodiment, the error dampening module 155 simply passes the adjusted frames 150 unmodified as the final frame 154 to video encoder 165. In the present embodiment, video encoder 165 generates encoded video data 160 by effectively encoding adjusted frames 150. It should be appreciated that video encoder 165 can implement any video encoding standard, including, but not limited to: H.261, H.263, H.264, MPEG-1, MPEG-2, MPEG-4 and other video encoding standards. It should be appreciated that in various embodiments of the present invention, error dampening module 155 is optional and is not included, such that adjusted frames 150 are transmitted as final frames 154 to video encoder 165 directly from frame adjuster 145.

In another embodiment, adjusted frames 150 are received and modified by the error dampening module 155. Error dampening module 155 is configured to generate an error-dampened adjusted frame by applying a blending filter to adjusted frame 150, such that the blending filter blends adjusted frame 150 with at least a portion of an input frame 110 corresponding to the adjusted frame 150.

In one embodiment, blending filter is applied to adjusted frame 150 to form final frame 154 \hat{x}ᵢ=a\hat{z}ᵢ+(1−a)yᵢ. This blending allows the long term AGC gain modifications to operate by injecting back a portion of input frame 110, yᵢ, and it also dampens errors in the estimates aᵢ and bᵢ that might otherwise accumulate. In one embodiment, a=0.99 is used.

In the present embodiment, final frame 154 \hat{x}ᵢ can be expressed as \hat{x}ᵢ=k₁yᵢ+k₂, where k₁ and k₂ are correction parameters for the input frame 110 yᵢ. This illustrates that artifact controller 102 applies an adaptive correction individually to each frame individually. Moreover, since there is no temporal filtering, artifact controller 102 does not cause smearing of the input video.

In one embodiment, final frames 154 are received at video encoder 165. In the present embodiment, video encoder 165 generates encoded video data 160 by encoding final frames 154. It should be appreciated that video encoder 165 can implement any video encoding standard, including, but not limited to: H.261, H.263, H.264, MPEG-1, MPEG-2, MPEG-4 and other video encoding standards.

As presented above, embodiments of the present invention rely on the assumptions that a portion of pixels do not change location between frames and that the global change induced by automatic exposure allows correction for automatic exposure errors. It should be appreciated that different forms and variations of the described embodiments are possible. For example, many different fitting methods may be used and the automatic exposure model does not need to be an affine fit. Alternately, in another embodiment, a clustering technique such as expectation-maximization algorithm together with an appropriate mixture model, such as on the residuals of collocated pixels, is used to estimate the parameters of the mixture and cluster the pixels into changing and non-changing classes, which are in turn used to proceed with a global fit.

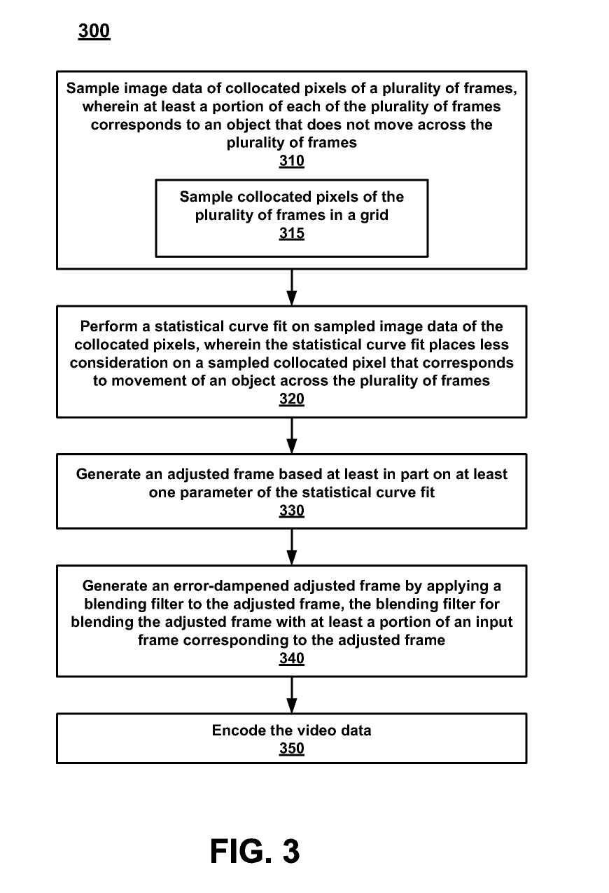

FIG. 3 is a flowchart illustrating a process 300 for controlling artifacts in video data, in accordance with one embodiment of the present invention. In one embodiment, process 300 is carried out by processors and electrical components under the control of computer readable and computer executable instructions. The computer readable and computer executable instructions reside, for example, in data storage features such as computer usable volatile and non-volatile memory. However, the computer readable and computer executable instructions may reside in any type of computer readable storage medium. In one embodiment, process 300 is performed by system 100 of FIG. 1.

At 310 of process 300, image data of collocated pixels of a plurality of frames is sampled, wherein at least a portion of each of the plurality of frames corresponds to an object that does not move across the plurality of frames. In one embodiment, the plurality of frames comprises consecutive frames of the video data. In one embodiment, as shown at 315 of process 300, the sampling includes sampling the collocated pixels of a plurality of frames in a grid. In one embodiment, the image data includes luminance data. In another embodiment, the image data includes RGB color space data.

At 320, a statistical curve fit is performed on sampled image data of the collocated pixels, wherein the statistical curve fit places less consideration on a sampled collocated pixel that corresponds to movement of an object across the plurality of frames. In one embodiment, the statistical curve fit includes a statistically robust curve fit. In one embodiment, the statistical curve fit includes a statistically robust linear fit. In another embodiment, the statistical curve fit includes a statistically robust linear fit.

At 330, an adjusted frame, e.g., an intermediate frame, based at least in part on at least one parameter of the statistical curve fit is generated. In one embodiment, the parameters include gain and offset.

In one embodiment, as shown at 340, an error-dampened adjusted frame, e.g., a final frame, is generated by applying a blending filter to the adjusted frame, the blending filter for blending the adjusted frame with at least a portion of an input frame corresponding to the adjusted frame.

In one embodiment, as shown at 350, the video data is encoded. In one embodiment, the video data is encoded using the adjusted frames. In another embodiment, the video data is encoded using the error-dampened adjusted frames.

Embodiments of the present invention provide for adjusting the video from stationary cameras, e.g., video conferences, so that quality degradation of entire video frame caused by subject motion is reduced. Embodiments of the present invention are compatible with existing encoder implementations and with existing cameras. Moreover, embodiments of the present invention do not require motion estimation, thereby reducing the complexity of the video data adjustment.

Furthermore, embodiments of the present invention do not require the motion to occur in a particular portion of the video. It is possible, for example, for some of the moving objects to be at the edge of the frame. As long as a portion of pixels are from stationary objects, the robust curve fitting can provide improved video data adjustment. Also, although various robust curve fits are iterative, the embodiments of the present invention are faster than traditional background/foreground segmentation. Moreover, embodiments of the present invention provide for keeping the benefits of AGC under changing lighting conditions while reducing the consequences of the errors caused by AGC.

Embodiments of the present invention provide for controlling artifacts in video data. Various embodiments of the present invention provide video processing, e.g., preconditioning, for controlling artifacts after image capture and before video encoding to avoid artifacts. In one embodiment, a statistically robust curve fit between collocated pixel values of consecutive frames for reducing automatic exposure errors is performed. In one embodiment, a blending filter is used to allow the automatic exposure to continue to operate while also stabilizing the system against accumulating errors of the robust curve fit.

Various embodiments of the present invention, controlling artifacts in video data, are thus described. While the present invention has been described in particular embodiments, it should be appreciated that the present invention should not be construed as limited by such embodiments, but rather construed according to the following claims.

What is claimed is:

1. A computer-implemented method (300) for controlling artifacts in video data, said method (300) comprising:
sampling (310) image data of collocated pixels of a plurality of frames of said video data, wherein at least a portion of each of said plurality of frames corresponds to an object that does not move across said plurality of frames;
performing (320) a statistical curve fit on sampled image data of said collocated pixels, wherein said statistical curve fit places less consideration on a sampled collocated pixel that corresponds to movement of an object across said plurality of frames; and
generating (330) an adjusted frame based at least in part on at least one parameter of said statistical curve fit.

2. The computer-implemented method (300) of claim 1 wherein said plurality of frames comprises consecutive frames of said video data.

3. The computer-implemented method (300) of claim 1 wherein said statistical curve fit comprises a statistically robust linear fit.

4. The computer-implemented method (300) of claim 1 wherein said statistical curve fit comprises a statistically robust parametric form fit.

5. The computer-implemented method (300) of claim 1 wherein said sampling (310) image data of collocated pixels of a plurality of frames of said video data comprises:
sampling (315) collocated pixels of a plurality of frames in a grid.

6. The computer-implemented method (300) of claim 1 wherein said image data comprises luminance data.

7. The computer-implemented method (300) of claim 1 wherein said image data comprises RGB color space data.

8. The computer-implemented method (300) of claim 1 wherein said at least one parameter comprises gain and offset.

9. The computer-implemented method (300) of claim 1 further comprising:
generating (340) an error-dampened adjusted frame by applying a blending filter to said adjusted frame, said blending filter for blending said adjusted frame with at least a portion of an input frame corresponding to said adjusted frame.

10. The computer-implemented method (300) of claim 1 further comprising:
encoding (350) said video data using said adjusted frame.

11. A computer-readable storage medium for storing instructions that when executed by one or more processors perform a method (300) controlling artifacts in video data, said method (300) comprising:
sampling (310) image data of collocated pixels of consecutive frames of said video data in a grid, wherein at least a portion of each of said consecutive frames corresponds to an object that does not move across said consecutive frames;
performing (320) a statistical curve fit on sampled image data of said collocated pixels, wherein said statistical curve fit places less consideration on a sampled collocated pixel that corresponds to movement of an object across said consecutive frames;
generating (330) an intermediate frame for one frame of said consecutive frames based at least in part on at least one parameter of said statistical curve fit; and
generating (340) a final frame by applying a blending filter to said intermediate frame, said blending filter for blending said intermediate frame with at least a portion of an input frame corresponding to said one frame.

12. The computer-readable storage medium of claim 11 wherein said statistical curve fit comprises a statistically robust linear fit.

13. The computer-readable storage medium of claim 11 wherein said statistical curve fit comprises a statistically robust parametric form fit.

14. The computer-readable storage medium of claim 11 wherein said method (300) further comprises:
encoding (350) said video data using said final, frame.

15. A system (100) for controlling artifacts in video data, said device comprising:
a video data receiver (115) for receiving image data comprising a plurality of frames of said video data;
a video data sampler (125) for sampling image data of collocated pixels of said plurality of frames, wherein at least a portion of each of said plurality of frames corresponds to an object that does not move across said plurality of frames;
a curve fitting module (135) for performing a statistical robust curve fit on sampled image data of said collocated pixels, wherein said statistical robust curve fit places less consideration on a sampled collocated pixel that corresponds to movement of an object across said plurality of frames; and
a frame adjuster (145) for generating an adjusted frame based at least in part on at least one parameter of said statistical curve fit.
